(19) United States
(12) Patent Application Publication
(10) Pub. No.: US 2020/0302914 A1
(43) Pub. Date: Sep. 24, 2020

(54) METHOD, DEVICE, COMPUTER APPARATUS, AND STORAGE MEDIUM OF PROCESSING CLAIM DATA

(71) Applicant: PING AN TECHNOLOGY (SHENZHEN) CO., LTD., Shenzhen (CN)

(72) Inventors: Huimin QIAN, Shenzhen (CN); Tongde XIANG, Shenzhen (CN); Xinwei YANG, Shenzhen (CN); Xu ZHANG, Shenzhen (CN)

(73) Assignees: PING AN TECHNOLOGY (SHENZHEN) CO., LTD., Shenzhen, GD (CN); PING AN TECHNOLOGY (SHENZHEN) CO., LTD., Shenzhen, GD (CN)

(21) Appl. No.: 16/082,862

(22) PCT Filed: Oct. 30, 2017
(86) PCT No.: PCT/CN2017/108378

§ 371 Date: Sep. 6, 2018

(30) Foreign Application Priority Data
Jul. 24, 2017 (CN) 201710607772.5

(51) Int. Cl. G10L 15/04; G10L 15/18; G10L 15/22; G10L 15/26; G06Q 40/08

(52) U.S. Cl. CPC G10L 15/04; G10L 15/1815; G10L 2015/088; G10L 15/265; G06Q 40/08; G10L 15/22

(57) ABSTRACT

A method of processing claim data includes: performing word segmentation for each piece of returning description information to obtain at least one claim word; determining at least one material claim word in the claim word; selecting at least one problem description claim word having a description relationship with each material claim word in the claim word; determining the number of association times that each problem description claim word is associated with the corresponding material claim word according to the description relationship between the problem description claim word and the corresponding material claim word; generating uploading verification logic for performing an uploading verification to the claim material according to each material claim word and the corresponding problem description claim word whose number of association times is above a preset threshold; adding the uploading verification logic to claim application page logic.

### CROSS REFERENCE TO RELATED APPLICATIONS

This application is a United States National Stage Application filed under 35 U.S.C 371 of PCT Patent Application Serial No. PCT/CN2017/108378, filed Oct. 30, 2017, which claims the priority of Chinese Patent Application No. 2017106077725, titled “METHOD, DEVICE, COMPUTER APPARATUS, AND STORAGE MEDIUM OF PROCESSING CLAIM DATA” and filed on Jul. 24, 2017, the contents of which are incorporated by reference herein in their entirety for all purposes.

### TECHNICAL FIELD

The present disclosure relates to the field of computer technology, and more particularly, to a method, device, computer apparatus and storage medium of processing claim data.

### BACKGROUND

With the continuous improvement of various social systems, enterprises no longer only pay attention to sales, but also strengthen after-sales service matters, such as claim matters. With the continuous development of science and technology, the claim matters are not limited to a user arriving at stores to handle, but the user may use an electronic equipment (such as a mobile phone) to apply for claims by himself.

Currently, the user may upload claim data through a client or a web page, and apply for claims by himself. However, since there are many types of claims, and users are often not familiar with a variety of claims requirements, a claim application is often returned due to a reason of an unqualified upload of claim data when submitting the claim application for review.

### SUMMARY

According to various embodiments of the present application, a method, device, computer apparatus and computer-readable storage medium of processing claim data are provided.

A method of processing claim data includes:

performing word segmentation for each piece of returning description information to obtain at least one claim word;

determining at least one material claim word in the claim word;

selecting at least one problem description claim word having a description relationship with each material claim word in the claim word;

determining the number of association times that each problem description claim word is associated with the corresponding material claim word according to the description relationship between the problem description claim word and the corresponding material claim word;

generating uploading verification logic for verifying an upload of a claim material according to each material claim word and the corresponding problem description claim word whose number of association times is above a preset threshold; and

adding the uploading verification logic to claim application page logic.

A device of processing claim data includes:

a word segmentation module, configured to perform word segmentation for each piece of returning description information to obtain a claim word;

a claim word determination module, configured to determine a material claim word in the claim word, and select a problem description claim word having a description relationship with each material claim word in the claim word;

an association times determination module, configured to determine the number of association times that each problem description claim word is associated with the corresponding material claim word according to the description relationship between the problem description claim word and the corresponding material claim word;

an uploading verification logic generation module, configured to generate uploading verification logic for verifying an upload of a claim material according to each material claim word and the corresponding problem description claim word whose number of association times is above a preset threshold; and

an add module, configured to add the uploading verification logic to claim application page logic.

A computer apparatus includes a processor and a memory storing computer-readable instructions, which, when executed by the processor cause the processor to perform steps including:

performing word segmentation for each piece of returning description information to obtain at least one claim word;

determining at least one material claim word in the claim word;

selecting at least one problem description claim word having a description relationship with each material claim word in the claim word;

determining the number of association times that each problem description claim word is associated with the corresponding material claim word according to the description relationship between the problem description claim word and the corresponding material claim word;

generating uploading verification logic for verifying an upload of a claim material according to each material claim word and the corresponding problem description claim word whose number of association times is above a preset threshold; and

adding the uploading verification logic to claim application page logic.

At least one non-transitory storage medium includes computer-readable instructions, which, when executed by one or more processors, cause the one or more processors to perform steps including:

performing word segmentation for each piece of returning description information to obtain at least one claim word;

determining at least one material claim word in the claim word;

selecting at least one problem description claim word having a description relationship with each material claim word in the claim word;

determining the number of association times that each problem description claim word is associated with the corresponding material claim word according to the description relationship between the problem description claim word and the corresponding material claim word;

generating uploading verification logic for verifying an upload of a claim material according to each material claim word and the corresponding problem description claim word whose number of association times is above a preset threshold; and

adding the uploading verification logic to claim application page logic.

The details of one or more implementations of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

To illustrate the technical solutions in the embodiments of the present disclosure more clearly, the accompanying drawings for describing the embodiments or the prior art are introduced briefly in the following. Apparently, the accompanying drawings in the following description are only some embodiments of the present disclosure, and persons of ordinary skill in the art can derive other drawings from the accompanying drawings without creative efforts.

FIG. 1 is a schematic diagram illustrating an environment adapted for a method of processing claim data according to one embodiment;

FIG. 2 is a schematic diagram of a computer apparatus according to one embodiment;

FIG. 3 is a flowchart illustrating a method of processing claim data according to one embodiment;

FIG. 4 is a flowchart illustrating a step of generating uploading verification logic according to one embodiment;

FIG. 5 is a flowchart illustrating a step of adding uploading verification logic according to one embodiment;

FIG. 6 is a block diagram of a device of processing claim data according to one embodiment;

FIG. 7 is a block diagram of an uploading verification logic generation module according to one embodiment; and

FIG. 8 is a block diagram of a device of processing claim data according to another embodiment.

### DETAILED DESCRIPTION OF THE EMBODIMENTS

In order to make the objectives, technical solutions, and advantages of the present disclosure more clear to understand, the following further describes the present disclosure in detail with reference to the accompanying drawings and embodiments. It should be appreciated that the specific embodiments described herein are only used to explain the present disclosure and are not used to limit the present disclosure.

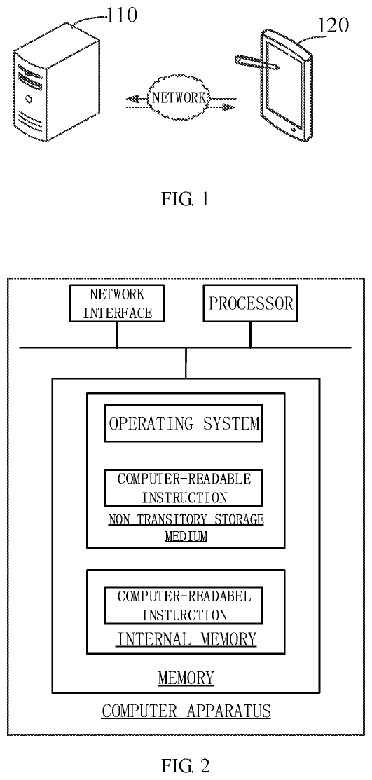

FIG. 1 is an application environment diagram of a method of processing claim data according to one embodiment. Referring to FIG. 1, the application environment includes a server 110 and a terminal 120 that are connected over a network. The server 110 can perform word segmentation for each piece of returning description information to obtain at least one claim word. The server 110 may determine at least one material claim word in the claim word, and select at least one problem description claim word having a description relationship with each material claim word in the claim word. The server 110 determines the number of association times that each problem description claim word is associated with the corresponding material claim word according to the description relationship between the problem description claim word and the corresponding material claim word. The server 110 generates uploading verification logic for performing an uploading verification to the claim material according to each material claim word and the corresponding problem description claim word whose number of association times is above a preset threshold, and adds the uploading verification logic to claim application page logic. Further, when a user accesses the claim application page through the terminal 120, the server 110 can send the claim application page logic added with last verification logic to the terminal 120.

FIG. 2 is a schematic diagram of internal structure of a computer apparatus according to one embodiment. The computer apparatus may be a server or a terminal. The server may be implemented as a stand-alone server or a server cluster composed of multiple servers. The server can be, but not limited to, at least one of a mobile terminal or a desktop computer. The mobile terminal may include at least one of a mobile phone, a tablet, a personal digital assistant and a wearable equipment. Referring to FIG. 2, the computer apparatus includes a processor, a memory and a network interface connected through a system bus. The memory includes a non-transitory storage medium and an internal memory. The non-transitory computer-readable storage media stores computer-readable instructions. When the computer-readable storage media is executed by the processor, the processor is caused to implement the method of processing claim data. The processor is configured to provide computing and control capabilities to support the operation of the entire computer apparatus. The internal memory of the computer apparatus may store computer-readable instructions. When the computer-readable storage media is executed by the processor, the processor is caused to implement the method of processing claim data. The internal memory of the computer apparatus provides an environment for an operation of the operating system and the computer-readable instructions in the non-transitory storage medium. The network interface of the computer apparatus is configured to connect to the network for communication.

Persons skilled in the art can understand that, the structure shown in FIG. 2 is only a part of the structure of the solution of the present disclosure, which does not impose limitation to the server. The computer apparatus can include more or less components than those shown in the drawing, or can combine some components, or can have different component deployment.

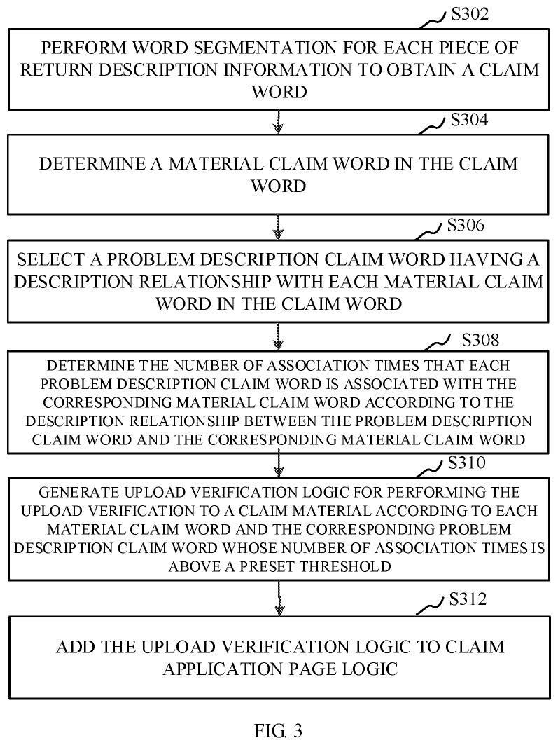

As shown in FIG. 3, in one embodiment, a method of processing claim data is provided. This embodiment is mainly illustrated as an example by the method being applied to the computer apparatus in FIG. 2 described above. Referring to FIG. 3, the method of processing claim data specifically includes the following steps:

In S302, word segmentation is performed for each piece of returning description information to obtain at least one claim word.

The returning description information refers to a described returning reason when an unqualified claim application is returned. The claim word refers to a word describing the returning reason when the claim application is returned. The claim word includes a material claim word and a problem description claim word. The material claim word refers to a word describing an unqualified claim material. The claim material refers to an application and/or certification material required to be provided for the claim application, such as a bill or a certificate or the like. The problem description claim word refers to a word describing the problem of the unqualified claim material. For example, problems such as unclear, un-uploaded or incomplete are all problem description claim words.

In one embodiment, the computer apparatus performs word segmentation for each piece of returning description information in the returning description information set (i.e. a sample set) to obtain the corresponding word segment. The claim word matching the word segment is found according to a preset claim word library, and the found claim word is the claim word recognized from the word segment.

Specifically, the computer apparatus may perform word segmentation for the returning description information via word segmentation methods, such as based on character matching or based on statistic. Further, the computer apparatus may calculate a matching degree between each word segment and each claim word in the claim word library, and select the claim word with the highest matching degree as the claim word matching the word segment. The matching degree may be analyzed according to the meaning of the word. For example, the word segment “bill” and the claim word “bill” in the claim word library represent the same meaning of the word, and the matching degree between them is the highest, and thus the word segment “bill” matches the claim word “bill”. For another example, the word segment “unclear” and the claim word “fuzzy” in the claim word library are synonyms, and the matching degree between them is the highest, and thus the word segment “unclear” matches the claim word “fuzzy”.

In S304, at least one material claim word in the claim word is determined.

A least one material claim word is determined.

In one embodiment, step S304 includes: finding a type corresponding to the obtained claim word according to a corresponding relationship between the claim word and the type pre-stored in a claim word library; selecting a claim word whose type being the claim material from the claim word as the material claim word.

Specifically, the computer apparatus may preset the corresponding relationship between the claim word and the type of the claim word in the preset claim word library. The type of the claim word includes types of claim material and material problem or the like. The computer apparatus may select a claim word whose corresponding type being the claim material from the claim word as the material claim word according to above corresponding relationship.

In another embodiment, the computer apparatus may preset the corresponding claim word library according to the type of the claim word, i.e., the claim word of the same type is set in the same claim word library, such as the preset material claim word library and the problem description claim word library. The type of the claim word in the material claim word library is claim material, and the material claim word library stores the material claim word. The type of the claim word in the problem description claim word library is material problem, and the problem description claim word library stores the problem description claim word. The computer apparatus may determine the claim word library in which the claim word obtained by the word segmentation is located, and determine the type of the claim word corresponding to the claim word obtained by the word segmentation according to the corresponding relationship between the claim word library and the type of the claim word. Among them, the claim word whose type is claim material is the material claim word. For example, the claim word obtained by the word segmentation is located in the material claim word library, and the type of the claim word obtained by the word segment is the claim material, so the claim word is the material claim word.

In another embodiment, step S304 includes: acquiring a part of speech of the obtained claim word, and determining the claim word of which part of speech being a noun as the material claim word. Part of speech is the gender of words in grammatical sense, and represents the category to which the word belongs, which includes nouns, verbs, adjectives, adverbs or prepositions. Specifically, the computer apparatus may obtain the part of speech of each claim word by analyzing the semantic of the context, and determine the claim word of which part of speech being a noun as the material claim word.

In S306, at least one problem description claim word having a description relationship with each material claim word in the claim word is selected.

If the problem description claim word is used to describe the material claim word, then there will be a description relationship between the two words. For example, if the returning description information is “the certificate is unclear, and the bill is incomplete”, among which, “certificate” and “bill” are material claim words, and “unclear” and “incomplete” are problem description claim words, then there is a description relationship between the material claim word “certificate” and the problem description claim word “unclear”, and there is a description relationship between the material claim word “bill” and the problem description claim word “incomplete”.

The computer apparatus may select a corresponding problem description claim word having the description relationship for each material claim word from all of the material claim words. There is at least one problem description claim word having a description relationship with one material claim word.

Specifically, the computer apparatus may select the problem description claim word in the claim word, perform context semantic analysis to the returning description information existed in each material claim word, and determine at least one problem description claim word having a description relationship with each material claim word.

In one embodiment, the computer apparatus may find a type corresponding to the obtained claim word according to a corresponding relationship between the claim word and the type pre-stored in a claim word library, and select a claim word whose type being the material problem from the claim word as the problem description claim word.

In another embodiment, the computer apparatus may determine the claim word library in which the claim word obtained by word segmentation is located, and determine the type of the claim word corresponding to the claim word obtained by word segmentation according to the corresponding relationship between the claim word library and the type of the claim word. The claim word whose type is the material problem is the problem description claim word.

In a yet another embodiment, the computer apparatus may further regard a claim word after removing the material claim word from the claim word obtained by the word segmentation as the problem description claim word.

In S308, the number of association times that each problem description claim word is associated with the corresponding material claim word is determined according to the description relationship between the problem description claim word and the corresponding material claim word.

The number of association times refers to the number of times that there is an association relationship between the problem description claim word and the material claim word.

It should be noted that, if there is a description relationship between the problem description claim word and the material claim word, there is an association relationship between them. The number of times that there is a description relationship between the problem description claim word and the material claim word and the number of association times (i.e., the number of association times) between the two is positively correlated.

In one embodiment, step 308 includes: determining the number of times that the description relationship is generated between each problem description claim word and the corresponding material claim word; and regarding the corresponding number of times that the description relationship is generated as the number of association times that each problem description claim word is associated with the corresponding material claim word.

The corresponding material claim word of the problem description claim word is the material claim word having the description relationship with the problem description claim word.

It can be understood that each piece of the returned description information may have an identical material claim word and a problem description claim word having a description relationship with the material claim word. Therefore, there is at least once of relationship between one material claim word obtained by the word segmentation of each piece of the returning description information in the returning description information set and one identical material claim word. For example, in the returning description information 1 “the certificate is unclear, and the bill is incomplete”, there is one time of description relationship between the material claim word “certificate” and the problem description claim word “unclear”. In the returning description information 2 “the certificate is unclear”, there is another time of description relationship between the material claim word “certificate” and the problem description claim word “unclear”. At this time, the material claim word “certificate” and the problem description claim word “unclear” have two times of description relationship.

The computer apparatus may count the number of times that a description relationship is generated between each problem description claim word having a description relationship with each material claim word and the corresponding material claim word, and regard the corresponding number of times that the description relationship is generated as the number of association times, i.e. the association times, that each problem description claim word generates an association relationship with the corresponding material claim word. In combination with the above example, there are 2 times of description relationship between the material claim word “certificate” and the problem description claim word “unclear”, and the number of association times between the them is 2.

In S310, uploading verification logic for performing an uploading verification to the claim material is generated according to each material claim word and the corresponding problem description claim word whose number of association times is above a preset threshold.

The uploading verification logic refers to a logic program code for performing the uploading verification to the claim material. Performing an uploading verification to a claim material is to verify whether the claim material is uploaded and/or the uploaded claim material is qualified when applying the claim application.

Specifically, the computer equipment may select the problem description claim word of which the number of association times associated with each material claim word exceeding the preset threshold, and then generate the uploading verification logic according to the material claim word and selected problem description claim word.

In S312, the uploading verification logic is added to claim application page logic.

The claim application page logic refers to a logic program code constituting the claim application page.

Specifically, the computer apparatus may determine the position for inserting the uploading verification logic in the claim application page logic according to the preset character, and then add the uploading verification logic to the claim application page logic according to the determined position.

According to the method of processing the claim data described above, the claim word is obtained by performing word segmentation for the returning description information. The association relationship between the material claim word and the problem description claim word of the claim word is analyzed. The problem description claim word of which the number of association times associated with the material claim word exceeding the preset threshold is selected. The selected problem description claim word may reflect the material represented by the material claim word and the common unqualified problem when applying the claim application. Then the uploading verification logic is generated and is added to the claim application page logic according to the material claim word and the selected problem description claim word. In this way, the uploading verification for the claim material may be performed when the user applies a claim application. The problem that usually exists in the claim material is verified when the user performs the claim application operation. The waste of time of the waiting period from the submission of the claim application to the claim material being returned is avoided, and thus the efficiency of the entire claim application is improved.

Further, analysis is performed according to the returned description information, and the uploading verification logic is generated and added to the claim application logic page automatically. In this way, there is no need to manually analyze a large amount of returning description information, and then manually compile the uploading verification logic and manually add to the claim application page. Thus, the efficiency of the feature improvement of the claim application page is improved.

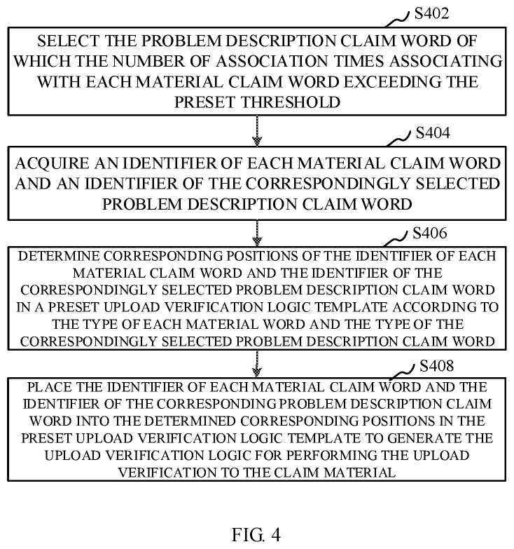

In one embodiment, as shown in FIG. 4, step S310 (referred to as an uploading verification logic generation step) specifically includes the following steps:

In S402, the problem description claim word of which the number of association times associated with each material claim word exceeding the preset threshold is selected.

In S404, an identifier of each material claim word and an identifier of the correspondingly selected problem description claim word are acquired.

The identifier of the claim word is used to uniquely identify the claim word. The identifier may be a character string, and the computer apparatus may acquire the identifier of each material claim word and the identifier of the correspondingly selected problem description claim word according to a mapping conversion relationship between the preset word and the character string. The identifier of the claim word may also be the claim word itself.

In S406, corresponding positions of the identifier of each material claim word and the identifier of the correspondingly selected problem description claim word in a preset uploading verification logic template is determined according to the type of each material word and the type of the correspondingly selected problem description claim word.

Specifically, the corresponding relationship between each position and the type of the claim word in the uploading verification logic template is preset in the computer apparatus. The computer apparatus may determine that the type corresponding to each material claim word is the type of the claim material, and determine that the type of the corresponding selected problem description claim word is the type of the material problem. The computer apparatus may determine the corresponding positions of the identifier of each material claim word and the identifier of the corresponding problem description claim word in the preset uploading verification logic template according to the above corresponding relationship.

In one embodiment, step S406 includes: determining the level of each material claim word and each corresponding problem description claim word in the uploading verification template, and determining the corresponding positions of the identifier of each material claim word and the identifier of the corresponding problem description claim word in the sub-verification logic template of the corresponding level according to the type of the material claim word and the type of each corresponding problem description claim word.

The uploading verification logic template is composed of a plurality of levels of sub-verification logic templates. The position corresponding to the type of the claim word is provided in the sub-verification logic template of each level. When there are a plurality of material claim words, it is necessary to determine the level corresponding to each material claim word and the corresponding problem description claim word. The high and low order of each level can be used to characterize the sequence of verification. The higher the level of the material claim word and the corresponding problem description claim word, the earlier the sub-verification logic corresponding to the generated uploading verification logic executes.

In one embodiment, when the computer apparatus performs the uploading verification logic, if it is discovered that the verification result of the execution of the sub-verification logic is unqualified, the execution of the next level of the sub-verification logic may be stopped to save resources. In the present embodiment, the computer apparatus may sum the number of association times between each material claim word and the corresponding problem description claim word, and the total number of association times between each material claim word and each corresponding problem description claim word is obtained. The level corresponding to each material claim word and the corresponding problem description claim word in the uploading verification template is determined according to the corresponding total number of association times. The high or the low order of the corresponding level is positively correlated with the corresponding total number of association times. For example, if the total number of association times of “bill” is 50, and the total number of association times of “certificate” is 20, it can be determined that the level corresponding to the “bill” and the corresponding problem description claim word in the uploading verification template is higher than the level corresponding to the “certification” and the corresponding problem description claim word in the uploading verification template. It should be understood that, the computer apparatus may also determine the level corresponding to each material claim word and the corresponding problem description claim word in the uploading verification template randomly.

It should be understood that, the total number of association times of each material claim word can be used to characterize the probability of the material characterized by the material claim word occurring an upload problem. The larger the total number of association times, the greater the probability of the material characterized by the material claim word occurring the upload problem is. Through increasing the level corresponding to the material claim word that the material characterized has a greater probability of occurring the upload problem and each of the corresponding problem description claim words in the uploading verification template, it is possible to preferentially verify the problems that are easy to occur, and the waste of resources caused by verifying the problems that are not easy to occur and consume resource firstly may be avoided.

In one embodiment, when there are a plurality of problem description claim words that have description relationship with one material claim word, the position order of each problem description claim word in the sub-verification logic template of the corresponding level may be determined according to the number of times of corresponding association with the material claim word. The order of each problem description claim word in the sub-verification logic template of the corresponding level is positively correlated with the number of the corresponding association times associated with the material claim word.

In S408, the identifier of each material claim word and the identifier of the corresponding problem description claim word is placed into the determined corresponding positions in the preset uploading verification logic template to generate the uploading verification logic for performing the uploading verification to the claim material.

Further, the computer apparatus may place the identifier of each material claim word and the identifier of the corresponding problem description claim word into the determined corresponding positions in the preset uploading verification logic template, and combine the identifier with the uploading verification logic template to generate the uploading verification logic.

In the above embodiment, the identifier of the material claim word and the identifier of the problem description claim word are determined and placed according to the corresponding type to generate the uploading verification logic, it is not necessary to provide a corresponding position corresponding to each material claim word and problem description claim word. Therefore, even if there are new material claim word and problem description claim word, there is no need to update the uploading verification logic template, and the usage rate of the uploading verification logic template is improved.

In one embodiment, the method further includes: determining corresponding positions of the identifier of each material claim word and the identifier of the correspondingly selected problem description claim word in a claim application illustration template according to the type of each material word and the type of the correspondingly selected problem description claim word; placing the identifier of each material claim word and the identifier of the corresponding problem description claim word into the determined corresponding positions in the preset claim application illustration template to generate a claim application illustration; adding the generated claim application illustration to a claim illustration column in a claim application page.

The claim application illustration refers to an illustration of the problem that is easy to occur during the claim application process, and may play a role of guiding and reminding.

Specifically, the computer apparatus presets the claim application illustration template, and presets the corresponding relationship between the type of the claim word and each position in the claim application illustration template. The computer apparatus may determine that the type corresponding to each material claim word is the type of claim material, and determine that the type corresponding to the correspondingly selected problem description claim word is the type of material problem. The computer apparatus may determine the corresponding positions of the identifier of each material claim word and the identifier of the correspondingly selected problem description claim word in a preset uploading verification logic template according to the above corresponding relationship.

Further, the computer apparatus may place the identifier of each material claim word and the identifier of the corresponding problem description claim word into the determined corresponding positions in the preset uploading verification logic template to generate the claim application illustration. For example, the claim application illustration includes: “the bill should not be incomplete, and the certificate should not be unclear” or the like. In the present embodiment, the claim illustration column is provided in the claim application page. The computer apparatus may add the generated claim application illustration to the claim illustration column in the claim application page, so as to guide and remind the user who performs the claim application, and prevent the material uploaded by the user from being unqualified and thus affecting the efficiency in case the user does not know the requirements.

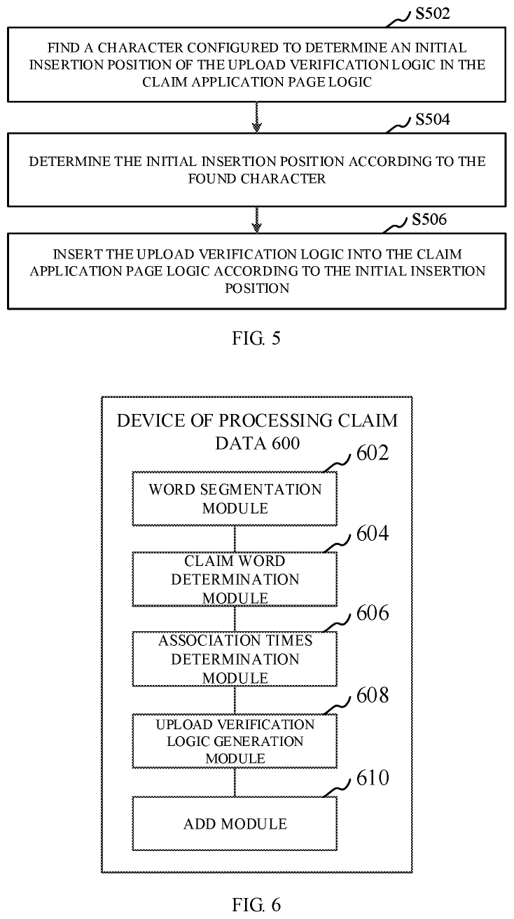

In one embodiment, as shown in FIG. 5, step S312 (referred to as the uploading verification logic adding step) specifically includes the following steps:

In S502, a character configured to determine an initial insertion position of the uploading verification logic is found in the claim application page logic.

The initial insertion position refers to the position at which the uploading verification logic begins to be added.

Specifically, the character configured to determine the initial insertion position of the uploading verification logic is preset in the computer apparatus. The computer apparatus may find the character configured to determine the initial insertion position of the uploading verification logic in the claim application page logic.

In S504, the initial insertion position is determined according to the found character.

Specifically, the computer apparatus may regard the character position of a preset number of bits before or after the found character as the initial insertion position. In one embodiment, the computer apparatus may regard the character position of one bit after the found character as the initial insertion position.

In S506, the uploading verification logic is inserted into the claim application page logic according to the initial insertion position.

Specifically, the computer apparatus may calculate the number of characters of the uploading verification logic to be inserted, and add a number of character positions between the initial insertion position and the subsequent character position of the initial insertion position in the claim application page logic, the number being corresponding to the determined number of characters, and the computer apparatus inserts the uploading verification logic into the added character position.

In the above embodiment, the uploading verification logic of any character length may be inserted flexibly by determining the initial insertion position, and the flexibility of adding logic is improved compared to the preset insertion position which is relatively fixed.

As shown in FIG. 6, in one embodiment, a device 600 of processing claim data is provided. The device includes: a word segmentation module 602, a claim word determination module 604, an association times determination module 606, an uploading verification logic generation module 608 and an add module 610.

The word segmentation module 602 is configured to perform word segmentation for each piece of returning description information to obtain at least one claim word.

The claim word determination module 604 is configured to determine at least one material claim word in the claim word, and select at least one problem description claim word having a description relationship with each material claim word in the claim word.

The association times determination module 606 is configured to determine the number of association times that each problem description claim word is associated with the corresponding material claim word according to the description relationship between the problem description claim word and the corresponding material claim word.

The uploading verification logic generation module 608 is configured to generate uploading verification logic for performing an uploading verification to the claim material according to each material claim word and the corresponding problem description claim word whose number of association times is above a preset threshold.

The add module 610 is configured to add the uploading verification logic to claim application page logic.

In one embodiment, the claim word determination module 604 is further configured to acquire a part of speech of the obtained claim word, and determine the claim word of which part of speech being a noun as the material claim word, or find a type corresponding to the obtained claim word according to a corresponding relationship between the claim word and the type pre-stored in a claim word library, and select a claim word whose type being the claim material from the claim word as the material claim word.

In one embodiment, the association times determination module 606 is further configured to determine the number of times that the description relationship is generated between each problem description claim word and the corresponding material claim word, and regard the corresponding number of times that the description relationship is generated as the number of association times that each problem description claim word is associated with the corresponding material claim word.

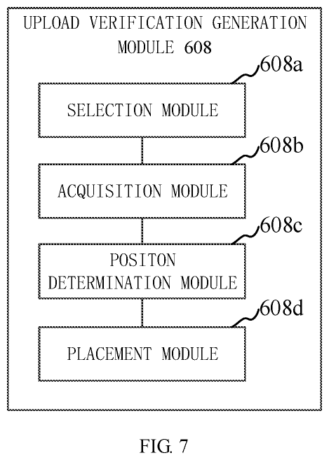

As shown in FIG. 7, in one embodiment, the uploading verification logic generation module 608 includes:

a selection module 608a, configured to select the problem description claim word of which the number of association times associated with each material claim word exceeding the preset threshold;

an acquisition module 608b, configured to acquire an identifier of each material claim word and an identifier of the correspondingly selected problem description claim word;

a position determination module 608c, configured to determine corresponding positions of the identifier of each material claim word and the identifier of the correspondingly selected problem description claim word in a preset uploading verification logic template according to the type of each material word and the type of the correspondingly selected problem description claim word;

a placement module 608d, configured to place the identifier of each material claim word and the identifier of the corresponding problem description claim word into the determined corresponding positions in the preset uploading verification logic template to generate the uploading verification logic for performing the uploading verification to the claim material.

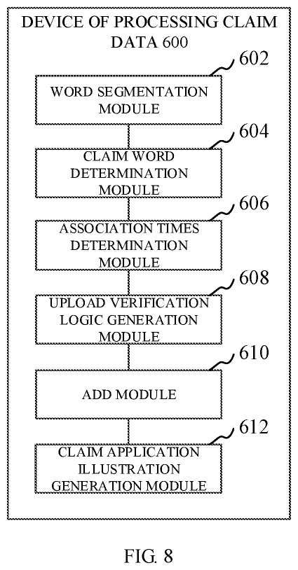

In one embodiment, the position determination module 608c is further configured to determine corresponding positions of the identifier of each material claim word and the identifier of the correspondingly selected problem description claim word in a preset uploading verification logic template according to the type of each material word and the type of the correspondingly selected problem description claim word. In the present embodiment, as shown in FIG. 8, the device 600 further includes:

a claim application illustration module 612, configured to place the identifier of each material claim word and the identifier of the corresponding problem description claim word into the determined corresponding positions in the preset claim application illustration template to generate a claim application illustration.

The add module 610 is further configured to add the generated claim application illustration to a claim illustration column in a claim application page.

In one embodiment, the add module 610 is further configured to find a character configured to determine an initial insertion position of the uploading verification logic in the claim application page logic, and determine the initial insertion position according to the found character, and insert the uploading verification logic into the claim application page logic according to the initial insertion position.

In one embodiment, a message push device provided in the present application may implement as a form of computer program. The computer program may be run on a computer apparatus as shown in FIG. 2. The non-transitory storage medium of the computer apparatus may store various program modules constituting the message pushing device, for example, the word segmentation module 602, the claim word determination module 604, the association times determination module 606, the uploading verification logic generation module 608 and the add module 610 as shown in FIG. 6. Computer program instructions are included in each program module. The computer readable instruction is configured to cause the computer apparatus to perform the steps in a message push method of various embodiments of the present application described in the present description. For example, the computer apparatus may perform word segmentation for each piece of returning description information to obtain at least one claim word through the word segmentation module 602 of the device 600 for processing claim data shown in FIG. 6, and determine the material claim word in the claim word through the claim word determination module 604; select at least one problem description claim word having a description relationship with each material claim word in the claim word. The computer apparatus may determine the number of association times that each problem description claim word is associated with the corresponding material claim word according to the description relationship between the problem description claim word and the corresponding material claim word through the association times determination module 606. The computer apparatus may generate the uploading verification logic for performing the uploading verification to the claim material according to each material claim word and the corresponding problem description claim word whose number of association times is above the preset threshold though the uploading verification logic generation module 608. The computer apparatus may add the uploading verification logic to claim application page logic through the add module 610.

In one embodiment, a computer apparatus is provided. The computer apparatus includes a memory, and a processor; computer-readable instructions are stored in the memory, when the computer-readable instruction is executed by the processor, the processor is caused to execute following steps: performing word segmentation for each piece of returning description information to obtain at least one claim word; determining at least one material claim word in the claim word; selecting at least one problem description claim word having a description relationship with each material claim word in the claim word; determining the number of association times that each problem description claim word is associated with the corresponding material claim word according to the description relationship between the problem description claim word and the corresponding material claim word; generating uploading verification logic for performing an uploading verification to the claim material according to each material claim word and the corresponding problem description claim word whose number of association times is above a preset threshold; adding the uploading verification logic to claim application page logic.

In one embodiment, the determining at least one material claim word in the claim word includes: acquiring a part of speech of the obtained claim word; determining the claim word of which part of speech being a noun as the material claim word; or finding a type corresponding to the obtained claim word according to a corresponding relationship between the claim word and the type pre-stored in a claim word library; selecting a claim word whose type being the claim material from the claim word as the material claim word.

In one embodiment, the determining the number of association times that each problem description claim word is associated with the corresponding material claim word according to the description relationship between the problem description claim word and the corresponding material claim word includes: determining the number of times that the description relationship is generated between each problem description claim word and the corresponding material claim word; regarding the corresponding number of times that the description relationship is generated as the number of association times that each problem description claim word is associated with the corresponding material claim word.

In one embodiment, the generating uploading verification logic for performing an uploading verification to the claim material according to each material claim word and the corresponding problem description claim word whose number of association times is above a preset threshold includes: selecting the problem description claim word of which the number of association times associated with each material claim word exceeding the preset threshold; acquiring an identifier of each material claim word and an identifier of the correspondingly selected problem description claim word; determining corresponding positions of the identifier of each material claim word and the identifier of the correspondingly selected problem description claim word in a preset uploading verification logic template according to the type of each material word and the type of the correspondingly selected problem description claim word; placing the identifier of each material claim word and the identifier of the corresponding problem description claim word into the determined corresponding positions in the preset uploading verification logic template to generate the uploading verification logic for performing the uploading verification to the claim material.

In one embodiment, the processor is caused by the computer-readable instruction to execute following steps: determining corresponding positions of the identifier of each material claim word and the identifier of the correspondingly selected problem description claim word in a claim application illustration template according to the type of each material word and the type of the correspondingly selected problem description claim word; placing the identifier of each material claim word and the identifier of the corresponding problem description claim word into the determined corresponding positions in the preset claim application illustration template to generate a claim application illustration; adding the generated claim application illustration to a claim illustration column in a claim application page.

In one embodiment, the adding the uploading verification logic to the claim application page logic includes: finding a character configured to determine an initial insertion position of the uploading verification logic in the claim application page logic; determining the initial insertion position according to the found character; inserting the uploading verification logic into the claim application page logic according to the initial insertion position.

At least one non-transitory computer-readable storage medium with computer-readable instructions stored thereon is provided. When the computer-readable instruction is executed by one or more processors, the one or more processors are caused to execute the following steps: performing word segmentation for each piece of returning description information to obtain at least one claim word; determining at least one material claim word in the claim word; selecting at least one problem description claim word having a description relationship with each material claim word in the claim word; determining the number of association times that each problem description claim word is associated with the corresponding material claim word according to the description relationship between the problem description claim word and the corresponding material claim word; generating uploading verification logic for performing an uploading verification to the claim material according to each material claim word and the corresponding problem description claim word whose number of association times is above a preset threshold; adding the uploading verification logic to claim application page logic.

In one embodiment, the determining at least one material claim word in the claim word includes: acquiring a part of speech of the obtained claim word; determining the claim word of which part of speech being a noun as the material claim word; or finding a type corresponding to the obtained claim word according to a corresponding relationship between the claim word and the type pre-stored in a claim word library; selecting a claim word whose type being the claim material from the claim word as the material claim word.

In one embodiment, the determining the number of association times that each problem description claim word is associated with the corresponding material claim word according to the description relationship between the problem description claim word and the corresponding material claim word includes: determining the number of times that the description relationship is generated between each problem description claim word and the corresponding material claim word; regarding the corresponding number of times that the description relationship is generated as the number of association times that each problem description claim word is associated with the corresponding material claim word.

In one embodiment, the generating uploading verification logic for performing the uploading verification to the claim material according to each material claim word and the corresponding problem description claim word whose number of association times is above a preset threshold includes: selecting the problem description claim word of which the number of association times associated with each material claim word exceeding the preset threshold; acquiring an identifier of each material claim word and an identifier of the correspondingly selected problem description claim word; determining corresponding positions of the identifier of each material claim word and the identifier of the correspondingly selected problem description claim word in a preset uploading verification logic template according to the type of each material word and the type of the correspondingly selected problem description claim word; placing the identifier of each material claim word and the identifier of the corresponding problem description claim word into the determined corresponding positions in the preset uploading verification logic template to generate the uploading verification logic for performing the uploading verification to the claim material.

In one embodiment, when the computer-readable instruction is executed by the processor, the processor are further caused to execute the following steps: determining corresponding positions of the identifier of each material claim word and the identifier of the correspondingly selected problem description claim word in a claim application illustration template according to the type of each material word and the type of the correspondingly selected problem description claim word; placing the identifier of each material claim word and the identifier of the corresponding problem description claim word into the determined corresponding positions in the preset claim application illustration template to generate a claim application illustration; adding the generated claim application illustration to a claim illustration column in a claim application page.

In one embodiment, the adding the uploading verification logic to the claim application page logic includes: finding a character configured to determine an initial insertion position of the uploading verification logic in the claim application page logic; determining the initial insertion position according to the found character; inserting the uploading verification logic into the claim application page logic according to the initial insertion position.

It should be understood that the steps in each embodiment of the present application are not necessarily performed sequentially in the order indicated by the step label. Unless explicitly stated herein, the execution of these steps do not have strict sequential constraints, and these steps may be executed in a different sequence. Furthermore, at least some of the steps in each embodiment may include a plurality of sub-steps or a plurality of stages that are not necessarily executed at the same time, but may be performed at different times. The order of execution of these sub-steps or stages is not necessarily sequential. Instead, it can be executed alternately or interchangeably with at least a portion of the steps or stages of another sub-step or stage.

A person skilled in the art should understand that all or part of the process for implementing the methods of the above embodiments can be completed by a computer-readable instruction instructing a related hardware. The computer-readable instructions may be stored in a computer-readable storage medium. The computer-readable instructions may implement the processes including in the embodiments of the various methods when it is being executed. The foregoing storage medium may be a non-transitory storage medium such as a magnetic disk, an optical disk, a read-only memory (ROM) or the like.

The technical features of the above-described embodiments may be combined arbitrarily. To make the description concise, all the possible combinations of the technical features in the above embodiments are not described. However, as long as there is no contradiction in the combination of these technical features, it should be considered as the scope of the present specification.

The foregoing implementations are merely specific embodiments of the present disclosure, and are not intended to limit the protection scope of the present disclosure. It should be noted that any modifications, equivalent alternations and improvements that are made within the spirit and scope of the present disclosure should be included in the protection scope of the present disclosure. Therefore, the protection scope of the present disclosure shall be subject to the protection scope of the claims.

1. A method of processing claim data, comprising:
performing word segmentation for each piece of returning description information to obtain at least one claim word;
determining at least one material claim word in the claim word;
selecting at least one problem description claim word having a description relationship with each material claim word in the claim word;
determining the number of association times that each problem description claim word is associated with the corresponding material claim word according to the description relationship between the problem description claim word and the corresponding material claim word;
generating uploading verification logic for performing an uploading verification to the claim material according to each material claim word and the corresponding problem description claim word whose number of association times is above a preset threshold; and
adding the uploading verification logic to claim application page logic.

2. The method of claim 1, wherein the determining at least one material claim word in the claim word comprises:
acquiring a part of speech of the obtained claim word; and
determining the claim word of which part of speech being a noun as the material claim word; or
finding a type corresponding to the obtained claim word according to a corresponding relationship between the claim word and the type pre-stored in a claim word library; and
selecting a claim word whose type being the claim material from the claim word as the material claim word.

3. The method of claim 1, wherein determining the number of association times that each problem description claim word is associated with the corresponding material claim word according to the description relationship between the problem description claim word and the corresponding material claim word comprises:
determining the number of times that the description relationship is generated between each problem description claim word and the corresponding material claim word; and
regarding the corresponding number of times that the description relationship is generated as the number of association times that each problem description claim word is associated with the corresponding material claim word.

4. The method of claim 1, wherein generating uploading verification logic for performing an uploading verification to a claim material according to each material claim word and the corresponding problem description claim word whose number of association times is above a preset threshold comprises:
selecting the problem description claim word of which the number of association times associated with each material claim word exceeding the preset threshold;
acquiring an identifier of each material claim word and an identifier of the correspondingly selected problem description claim word;
determining corresponding positions of the identifier of each material claim word and the identifier of the correspondingly selected problem description claim word in a preset uploading verification logic template according to the type of each material word and the type of the correspondingly selected problem description claim word; and
placing the identifier of each material claim word and the identifier of the corresponding problem description claim word into the determined corresponding positions in the preset uploading verification logic template to generate the uploading verification logic for performing an uploading verification to the claim material.

5. The method of claim 4, further comprising:
determining corresponding positions of the identifier of each material claim word and the identifier of the correspondingly selected problem description claim word in a claim application illustration template according to the type of each material word and the type of the correspondingly selected problem description claim word;
placing the identifier of each material claim word and the identifier of the corresponding problem description claim word into the determined corresponding positions in the preset claim application illustration template to generate a claim application illustration; and
adding the generated claim application illustration to a claim illustration column in a claim application page.

6. The method of claim 1, wherein adding the uploading verification logic to the claim application page logic comprises:
finding a character configured to determine an initial insertion position of the uploading verification logic in the claim application page logic;
determining the initial insertion position according to the found character; and
inserting the uploading verification logic into the claim application page logic according to the initial insertion position.

7-8. (canceled)

9. A computer apparatus, comprising a processor and a memory storing computer-readable instructions, which, when executed by the processor cause the processor to perform steps comprising:
performing word segmentation for each piece of returning description information to obtain at least one claim word;
determining at least one material claim word in the claim word;
selecting at least one problem description claim word having a description relationship with each material claim word in the claim word;
determining the number of association times that each problem description claim word is associated with the corresponding material claim word according to the description relationship between the problem description claim word and the corresponding material claim word;
generating uploading verification logic for performing an uploading verification to the claim material according to each material claim word and the corresponding problem description claim word whose number of association times is above a preset threshold; and
adding the uploading verification logic to claim application page logic.

10. The computer apparatus of claim 9, wherein the determining at least one material claim word in the claim word, which is executed by the processor, comprises:
acquiring a part of speech of the obtained claim word; and
determining the claim word of which part of speech being a noun as the material claim word; or
finding a type corresponding to the obtained claim word according to a corresponding relationship between the claim word and the type pre-stored in a claim word library; and
selecting a claim word whose type being the claim material from the claim word as the material claim word.

11. The computer apparatus of claim 9, wherein determining the number of association times that each problem description claim word is associated with the corresponding material claim word according to the description relationship between the problem description claim word and the corresponding material claim word, which is executed by the processor, comprises:
determining the number of times that the description relationship is generated between each problem description claim word and the corresponding material claim word; and
regarding the corresponding number of times that the description relationship is generated as the number of association times that each problem description claim word is associated with the corresponding material claim word.

12. The computer apparatus of claim 9, wherein generating uploading verification logic for performing an uploading verification to the claim material according to each material claim word and the corresponding problem description claim word whose number of association times is above a preset threshold, which is executed by the processor comprises:
selecting the problem description claim word of which the number of association times associated with each material claim word exceeding the preset threshold;
acquiring an identifier of each material claim word and an identifier of the correspondingly selected problem description claim word;
determining corresponding positions of the identifier of each material claim word and the identifier of the correspondingly selected problem description claim word in a preset uploading verification logic template according to the type of each material word and the type of the correspondingly selected problem description claim word; and
placing the identifier of each material claim word and the identifier of the corresponding problem description claim word into the determined corresponding positions in the preset uploading verification logic template to generate the uploading verification logic for performing the uploading verification to the claim material.

13. The computer apparatus of claim 12, wherein the processor is caused by the computer-readable instruction to execute following steps:
determining corresponding positions of the identifier of each material claim word and the identifier of the correspondingly selected problem description claim word in a claim application illustration template according to the type of each material word and the type of the correspondingly selected problem description claim word;
placing the identifier of each material claim word and the identifier of the corresponding problem description claim word into the determined corresponding positions in the preset claim application illustration template to generate a claim application illustration; and
adding the generated claim application illustration to a claim illustration column in a claim application page.

14. The computer apparatus of claim 9, wherein adding the uploading verification logic to the claim application page logic, which is executed by the processor comprises:
finding a character configured to determine an initial insertion position of the uploading verification logic in the claim application page logic;
determining the initial insertion position according to the found character; and
inserting the uploading verification logic into the claim application page logic according to the initial insertion position.

15. At least one non-transitory storage medium, comprising computer-readable instructions, which, when executed by one or more processors, cause the one or more processors to perform steps comprising:
performing word segmentation for each piece of returning description information to obtain at least one claim word;
determining at least one material claim word in the claim word;
selecting at least one problem description claim word having a description relationship with each material claim word in the claim word;
determining the number of association times that each problem description claim word is associated with the corresponding material claim word according to the description relationship between the problem description claim word and the corresponding material claim word;
generating uploading verification logic for performing an uploading verification to the claim material according to each material claim word and the corresponding problem description claim word whose number of association times is above a preset threshold; and
adding the uploading verification logic to claim application page logic.

16. The non-transitory storage medium of claim 15, wherein determining at least one material claim word in the claim word, which is executed by the processor, comprises:
acquiring a part of speech of the obtained claim word; and
determining the claim word of which part of speech being a noun as the material claim word; or
finding a type corresponding to the obtained claim word according to a corresponding relationship between the claim word and the type pre-stored in a claim word library; and
selecting a claim word whose type being the claim material from the claim word as the material claim word.

17. The non-transitory storage medium of claim 15, wherein determining the number of association times that each problem description claim word is associated with the corresponding material claim word according to the description relationship between the problem description claim word and the corresponding material claim word, which is executed by the processor, comprises:
determining the number of times that the description relationship is generated between each problem description claim word and the corresponding material claim word; and
regarding the corresponding number of times that the description relationship is generated as the number of association times that each problem description claim word is associated with the corresponding material claim word.

18. The non-transitory storage medium of claim 15, wherein generating uploading verification logic for performing the uploading verification to the claim material according to each material claim word and the corresponding problem description claim word whose number of association times is above a preset threshold, which is executed by the processor, comprises:
selecting the problem description claim word of which the number of association times associated with each material claim word exceeding the preset threshold;
acquiring an identifier of each material claim word and an identifier of the correspondingly selected problem description claim word;
determining corresponding positions of the identifier of each material claim word and the identifier of the correspondingly selected problem description claim word in a preset uploading verification logic template according to the type of each material word and the type of the correspondingly selected problem description claim word; and
placing the identifier of each material claim word and the identifier of the corresponding problem description claim word into the determined corresponding positions in the preset uploading verification logic template to generate the uploading verification logic for performing the uploading verification to the claim material.

19. The non-transitory storage medium of claim 18, wherein the processor is caused by the computer-readable instructions to execute following steps:
determining corresponding positions of the identifier of each material claim word and the identifier of the correspondingly selected problem description claim word in a claim application illustration template according to the type of each material word and the type of the correspondingly selected problem description claim word;
placing the identifier of each material claim word and the identifier of the corresponding problem description claim word into the determined corresponding positions in the preset claim application illustration template to generate a claim application illustration; and
adding the generated claim application illustration to a claim illustration column in a claim application page.

20. The non-transitory storage medium of claim 15, wherein adding the uploading verification logic to the claim application page logic, which is executed by the processor, comprises:
finding a character configured to determine an initial insertion position of the uploading verification logic in the claim application page logic;
determining the initial insertion position according to the found character; and
inserting the uploading verification logic into the claim application page logic according to the initial insertion position.
